(19) United States
(12) Patent Application Publication
(10) Pub. No.: US 2003/0145059 A1
(43) Pub. Date: Jul. 31, 2003

(54) Server system for preparation of information for users in at least one communication network

(76) Inventors: Thomas Burgard, Munich (DE); York Hochheim, Munch (DE); Axel Kreten, Puchheim (DE)

Correspondence Address: MORRISON & FOERSTER LLP, 1650 TYSONS BOULEVARD, SUITE 300, MCLEAN, VA, 22102, US

(21) Appl. No.: 10/203,290

(22) PCT Filed: Feb. 9, 2001
(86) PCT No.: PCT/DE01/00504

(30) Foreign Application Priority Data
Feb. 10, 2000 (DE) 100 05 789.6

(51) Int. Cl. G06F 15/16

(52) U.S. Cl. 709/206

(57) ABSTRACT

The invention relates to a server system, for preparation of information for users in at least one communication network. According to the invention, the server system comprises a collection device for collecting status information regarding the status of mailbox messages from several and different mailbox servers, a storage device, with mailbox server information, indicating which of the mailbox servers has transmitted status information automatically to the collection device and which of the mailbox servers is to be interrogated by the collection device, for the transmission of status information and a transmission device which furnishes a user of the collection device with the received status information corresponding to the mailbox server information, relating to mailbox messages which are stored for said user in the mailbox servers. The invention allows an easy and uniform preparation of status information from various mailbox servers in various forms of communication networks, such as, for example, a telephone fixed network, the internet and similar.

The present invention relates to a server system and a method for providing information for subscribers in at least one communications network. In this case, the present invention relates in particular to the provision of status information relating to the status of mailbox messages from a number of mailbox servers, which may also be different, with the mailbox servers either transmitting the status information automatically, or being checked for the transmission of the status information.

The use of mailboxes for speech information, fax information, E-mail information and the like is becoming ever more widespread. In general, mailbox messages such as these are each stored in a mailbox server, in which case the relevant subscriber for whom newly arriving mailbox messages are intended must either himself regularly check and, if appropriate, call up his mailbox messages, or the subscriber is informed by means of status informed of the arrival of a new mailbox message, or a number of new messages, on his associated telephone set, for example a mobile telephone, on the landline telephone at home, or in the office. Once a subscriber has been informed in this way of a newly arriving mailbox message, he can retrieve it from the respective mailbox server and can listen to it on his telephone set, or can have it displayed on any screen which may be present.

By way of example, the MWI (Message Waiting Indication) service feature which is defined in the ETSI standard (European Telecommunication Standard Institute) provides the status information that a new mailbox message is waiting only from a separate mailbox server in each case (voicemail, faxmail, E-mail etc). This status information is displayed on the telephone terminal (analog telephone, ISDN telephone, mobile telephone or the like) of the relevant subscriber. Depending on the display capability of the telephone terminal and the signaling capability of the associated switching center to the telephone terminal (analog telephone with additional signaling, for example by means of frequency shift keying FSK, or an ISDN telephone with a functional protocol or stimulus protocol), the display may be simple, such as “message waiting” or more extensive, with, for example, the number and type of newly arriving mailbox messages, the date and time of receipt and the like being displayed. Mailbox servers now exist which provide status information automatically as soon as the status of the mailbox messages for a particular subscriber has changed, and mailbox servers which need to be checked in order to receive the respective up-to-date status information.

The system outlined above for provision of status information relating to the status of the mailbox messages has the disadvantage that the status information is provided only on telephone sets. Furthermore, there is no standard capability for providing overall status information relating to the status of mailbox messages in a number of different mailbox servers, when the mailbox servers contain mailbox messages in different message formats, or of providing the status information in a different way by checking or by automatic provision.

The object of the present invention is thus to provide a server system and a method for providing information for subscribers in at least one communications network, which provide a subscriber in a simple standard manner with the status information relating to the status of the mailbox messages which relate to him in a number of mailbox servers.

The above object is achieved by a server system for providing information for subscribers in at least one communications network as claimed in claim 1, which has a collecting device for collecting status information relating to the status of mailbox messages from a number of mailbox servers, has a memory device with mailbox server information, which indicates which of the mailbox servers have transmitted status information automatically to the collecting device and which of the mailbox servers need to be checked by the collecting device for the transmission of status information, and has a transmitting device, which supplies to the at least one subscriber status information which has been received by the collecting device on the basis of the mailbox server information and which relates to mailbox messages which are stored for the at least one subscriber in the mailbox servers.

The above object is also achieved by a method for providing information for subscribers in at least one communications network as claimed in claim 10, comprising the steps of: collection of status information relating to the status of mailbox messages from a number of mailbox servers on the basis of stored mailbox server information which indicates which of the mailbox servers has automatically transmitted status information and which of the mailbox servers need to be checked for the transmission of status information, and transmission of status information, which has been received on the basis of the mailbox server information, to a subscriber, with the mailbox server information relating to mailbox messages which are stored for this subscriber in the mailbox servers.

The present invention therefore allows status information relating to the status of mailbox messages to be provided in a simple and standard manner from a number of mailbox servers for one subscriber, even if the mailbox servers contain mailbox messages in different message formats and/or provide the status messages in different ways.

The collecting device advantageously automatically receives the status information from those mailbox servers which transmit the status information automatically whenever the status of the mailbox messages which relate to a particular subscriber change.

The collecting device furthermore advantageously transmits a checking message at a specific checking rate to the mailbox servers which need to be checked, in order then to receive the status information. In this case, the transmitting device can monitor the activity of the subscribers in the communications network, and the collecting device can change the checking rate as a function of the activity of a particular subscriber. By way of example, the communications network is the Internet, and the collecting device increases the checking rate for a subscriber while the subscriber is active on the Internet, for example by means of a computer or the like. In this case, the collecting device can transmit a checking message to the mailbox servers which need to be checked, in order to update the status information when the subscriber goes online or offline. This ensures that the subscriber always receives the latest status information via his mailboxes.

The communications network may also be a telephone network, with the collecting device transmitting a checking message to the mailbox servers which need to be checked, in order to update the status information when a particular subscriber is active in the telephone network, for example by means of a landline connection or a mobile telephone.

The collecting device furthermore advantageously transmits a checking message to the mailbox servers which need to be checked, in order to update the status information when the transmitting device receives from a particular subscriber a message to check the status of its mailbox messages.

Advantageous refinements of the method for providing information for subscribers in a communications network as claimed in claim 10 are defined in the corresponding dependent claims.

The server system according to the invention and the method according to the invention have the advantage that subscribers always receive a standard and up-to-date version of the status information relating to the status of all their mailbox messages in the various mailbox servers. In the case of mailbox servers which spontaneously signal every status change to the associated mailbox which is allocated to that subscriber, the subscriber always receives an up-to-date indication on his respective terminal, such as a computer, telephone or the like, with the only delays being those resulting from network propagation times and processing times in the servers. In the case of mailbox servers which signal the respective status of the associated mailbox which is allocated to the appropriate subscriber only by checking by the collecting device according to the invention, the subscriber likewise receives relatively up-to-date status information, and the extent to which this has been updated is delayed somewhat less, by virtue of the method, and at most by the checking rate.

The present invention will be explained in more detail in the following description using a preferred exemplary embodiment and with reference to the single FIGURE.

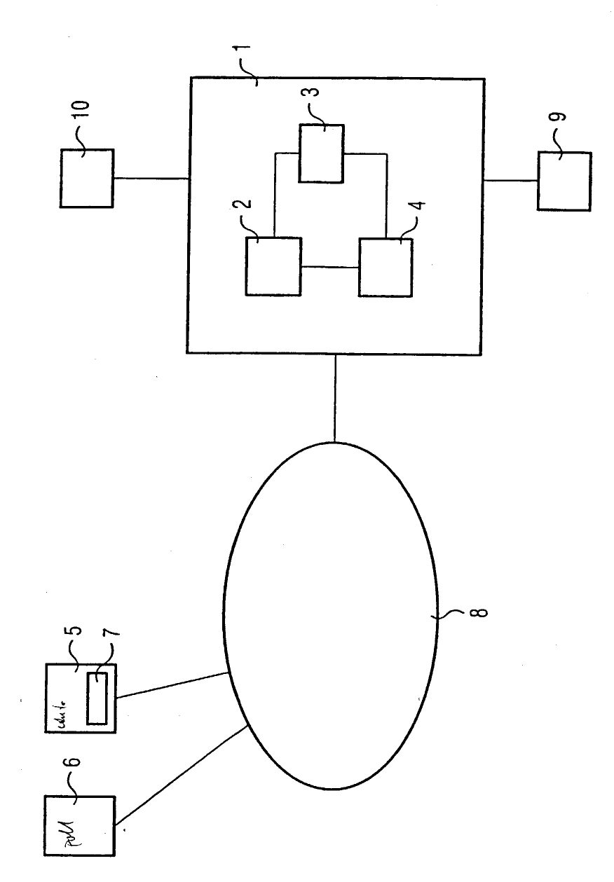

FIG. 1, which illustrates, schematically, a server system according to the invention and a number of mailbox servers which are connected to the server system according to the invention via the Internet.

FIG. 1 shows a communications system in which a server system 1 according to the invention is implemented in order to provide information for subscribers in a communications network, for example in a single server unit. The server system 1 has a collecting device 2 for collecting status information relating to the status of mailbox messages from a number of mailbox servers 5, 6. The server system 1 furthermore has a memory device 3 with mailbox server information which indicates which of the mailbox servers 5 has automatically transmitting status information to the collecting device 2 and which of the mailbox servers 6 need to be checked by the collecting device 2 for the transmission of status information. The server system 1 also has a transmitting device 4, which supplies a subscriber with status information which has been received by the collecting device 2 on the basis of the mailbox server information and relates to mailbox messages which are stored for the subscriber in the mailbox servers 5, 6.

The server system 1 and the mailbox servers 5, 6 are connected via the Internet 8. A subscriber to whom the status of the mailbox messages which are stored for him in the mailbox servers 5, 6 is intended to be provided is likewise connected to the server system 1 via a communications network, which may, for example, likewise be the Internet or else a telephone network or the like. The subscriber is provided with the status information, which is provided by the server system 1, on the respective terminal, such as a mobile telephone, computer, landline telephone or the like, for example on a display.

The communications system which is illustrated in FIG. 1 has a first mailbox server 5 and a second mailbox server 6, which illustrate the two fundamental options of providing status information from mailbox servers via a server system 1. The first mailbox server 5 sends the status information itself automatically to the server system 1 (a spontaneous signal) whenever a status change occurs, that is to say whenever a new mailbox message arrives and whenever a subscriber reads and deletes an existing mailbox message. To do this, additional devices are required in the mailbox server 5, such as an adapter device 7 which, for example, may be implemented in the form of software in the mailbox server 5. The adapter device 7 contains information about which mailboxes, that is to say which mailbox messages for which subscribers, need to be monitored for status changes, and to where the status information should be sent, that is to say to which terminal and to which server system 1. The adapter device 5 also contains a monitoring device, which is specific for the respective mailbox server 5 and depends on the operating system of the mailbox server 5 and on the software of the mailbox server 5 itself. The status information which is transmitted from the mailbox server 5 to the server system 1 is in principle updated taking account of the processing times in the mailbox server 5 and the propagation times in the communications network 8.

The mailbox server 6 is checked cyclically, that is to say at a specific checking rate, by the collecting device 2 in the server system 1, and is requested to transmit up-to-date status information. In this case, it is important that the collecting device 2 initiates and carries out the check of the status information without any status change to the relevant mailboxes in the mailbox server 6. If the communications network 8 is the Internet, the Internet protocols POP3 and IMAP4 are suitable for this purpose, which allow such checks without status changes. No additional devices are required in the mailbox server 6 for the periodic checks of that mailbox server 6. However, this results in a problem in that the status which is transmitted to the collecting device 2 cannot be more up-to-date than is allowed by the checking rate. In order that the status of the mailboxes for a subscriber in the server system 1 are always up-to-date, the mailbox server 6 must therefore be checked at very short time intervals, for example once a second. However, such short checking cycles place a load on the communications network 8 and on the relevant mailbox servers. Furthermore, the checking process can be carried out only sequentially, by virtue of the protocols, for each mailbox server 6, so that if there are a large number of mailboxes in the mailbox server 6, the cycle for each mailbox will be very long. This means that the status information in the server system 1 is not always up-to-date, and that the subscriber will not receive up-to-date status information.

It is thus worthwhile providing a low checking rate, which is compatible with the network, with the mailbox server being checked by additional status checks, in addition to the specified checking rate, in response to specific stimuli resulting from the activity of a subscriber. If, for example, a subscriber deliberately checks his mailbox states, for example by dialing an access code for the check, then, before this order is carried out, the status information will be additionally checked with regard to the status of the mailbox messages of the mailboxes which need to be checked in the mailbox server 6, that is to say the status information will be updated.

If the subscriber is active on the Internet via a computer, then the status information relating to his mailbox messages in the mailbox server 6 can be updated by additional checks when the subscriber goes online or offline. In this case, the checking rate can be increased while the subscriber is active on the Internet, or is online. If the subscriber is active via a telephone in a telephone network, for example when setting up an incoming or outgoing connection, then the status information can likewise be updated by an additional check by the collecting device 2 with the mailbox server 6.

It should be noted that the server system 1 according to the invention normally collects status information from a relatively large number of mailbox servers, not only from two mailbox servers 5 and 6 as illustrated in FIG. 1. The mailbox servers may in this case each contain different message formats, such as voicemail, faxmail, E-mail etc. Furthermore, at least some of the mailbox servers may be arranged in different communications networks—for example a voicemail server may be arranged in the telephone network and an E-mail server in the Internet, in which case the subscriber is arranged, and/or is active, and/or is accessible not only in the telephone network but also on the Internet. The server system according to the invention thus makes it possible to provide all the status information relating to the mailboxes relating to one subscriber in the various mailbox servers in a standard manner, with the status information being provided virtually at the same time in each communications network in which the subscriber is arranged, can be accessed or is active.

This option can be implemented in a particularly advantageous manner if the server system 1 according to the invention is connected to a digital switching center 9 of a telephone network in which the MWI service feature is provided in accordance with the ETSI standard. Since this service feature in accordance with the ETSI standard is already defined and provided in the telephone network, the status information relating to the mailboxes for a subscriber can thus also be provided in a simple and efficient manner via other communications networks, such as the Internet. The communication between the server system 1 and the digital switching center 9 in this case advantageously takes place on the basis of the Transaction Capabilities Application Part (TCAP), which is defined in the Signaling System No. 7.

The server system 1 according to the invention may also be connected to a user-program interface 10 for further applications. The collecting device 2 for collecting the status information, the memory device 3 with the data bank which contains information as to the mailbox server from which the status for which subscriber can be obtained by periodic checks, and which mailbox servers signal the up-to-date status information spontaneously to the collecting device 2 for which subscriber whenever a status change occurs, and the transmitting device 4 for transmitting the status information to a particular subscriber and for monitoring the activity of subscribers in the communications network, are advantageously implemented in the form of software. A subscriber may, for example, be supplied with the status information relating to his mailbox via the Internet 8 via a computer, and/or via a telephone set and via a telephone network, which is connected to the server system 1 by means of the digital switching center 9.

Each subscriber who, according to the invention, receives all his status information relating to all his mailboxes by means of the server system, is thus guaranteed that the status information which is provided will always be as up-to-date as possible. Delays can occur only as a result of network propagation times and processing times in the mailbox servers and in the server system 1. The greater the number of mailbox servers from which the status information is transmitted to the server system 1 spontaneously, as in the case of the mailbox server 5, the less significant is the load on the communications network 8 resulting from the checking of the remaining mailbox servers, for example the mailbox server 6, that is to say the checking times for these remaining mailbox servers can, if required, be reduced, thus making the status information which is provided even more up-to-date.

1. A server system (1) for providing information for subscribers in at least one communications network,
having a collecting device (2) for collecting status information relating to the status of mailbox messages from a number of mailbox servers (5, 6),
having a memory device (3) with mailbox server information, which indicates which of the mailbox servers (5) have transmitted status information automatically to the collecting device (2) and which of the mailbox servers (6) need to be checked by the collecting device (2) for the transmission of status information, and
having a transmitting device (4), which supplies to the at least one subscriber status information which has been received by the collecting device (2) on the basis of the mailbox server information and which relates to mailbox messages which are stored for the at least one subscriber in the mailbox servers (5, 6).

2. The server system (1) as claimed in claim 1, characterized
in that the collecting device (2) automatically receives the status information from those mailbox servers (5) which transmit the status information automatically whenever the status of the mailbox messages which relate to a particular subscriber change.

3. The server system (1) as claimed in claim 1 or 2, characterized
in that the collecting device (2) transmits a checking message at a specific checking rate to the mailbox servers (6) which need to be checked, in order then to receive the status information.

4. The server system (1) as claimed in claim 3, characterized
in that the transmitting device (4) monitors the activity of the subscribers in at least one of the at least one communications networks, and the collecting device (2) changes the checking rate, and/or initiates additional checks, as a function of the activity of a particular subscriber.

5. The server system (1) as claimed in claim 3 or 4, characterized
in that the at least one communications network is the Internet, a communications network which is based on TCP/IP protocols, or a packet-oriented or cell-oriented communications network, and the collecting device (2) increases the checking rate for a subscriber while the subscriber is active on the Internet.

6. The server system (1) as claimed in claim 5, characterized
in that the collecting device (2) transmits a checking message to the mailbox servers (6) which need to be checked, in order to update the status information when the subscriber goes online or offline.

7. The server system (1) as claimed in one of claims 4 to 6, characterized
in that the at least one communications network is a mobile or wire-connected telephone network, and the collecting device (2) transmits a checking message to the mailbox servers (6) which need to be checked, in order to update the status information when a particular subscriber is active in at least one of the at least one communications networks.

8. The server system (1) as claimed in one of claims 4 to 7, characterized
in that the collecting device (2) transmits a checking message to the mailbox servers (6) which need to be checked, in order to update the status information when the transmitting device receives from a particular subscriber a message for checking the status of his mailbox messages.

9. The server system (1) as claimed in one of claims 1 to 8, characterized
in that at least some of the mailbox servers (6) are arranged in different communications networks.

10. A method for providing information for subscribers in at least one communications network, comprising the following steps:
collection of status information relating to the status of mailbox messages from a number of mailbox servers on the basis of stored mailbox server information which indicates which of the mailbox servers has automatically transmitted status information and which of the mailbox servers need to be checked for the transmission of status information, and
transmission of status information, which has been received on the basis of the mailbox server information, to the at least one subscriber, with the mailbox server information relating to mailbox messages which are stored for this subscriber in the mailbox servers.

11. The method as claimed in claim 10, characterized
in that the status information is transmitted automatically by those mailbox servers which transmit the status information automatically whenever the status of the mailbox messages which relate to a particular subscriber change.

12. The method as claimed in claim 10 or 11, characterized
in that a checking message is transmitted at a specific checking rate to the mailbox servers which need to be checked, in order then to receive the status information.

13. The method as claimed in claim 12, characterized
in that the activity of the at least one subscriber in at least one of the at least one communications networks is monitored, and the checking rate is changed as a function of the activity of a particular subscriber.

14. The method as claimed in claim 12 or 13, characterized
in that the at least one communications network is the Internet or is in the form of a communications network configured in accordance with TCP/IP protocols or in the form of a packet-oriented or cell-oriented communications network, and the checking rate for a subscriber is increased while the subscriber is active in the communications network.

15. The method as claimed in claim 14, characterized
in that a checking message is transmitted to the mailbox servers which need to be checked, in order to update the status information when the at least one subscriber goes online or offline.

16. The method as claimed in one of claims 13 to 15, characterized
in that the at least one communications network is a mobile or wire-connected telephone network, and a checking message is transmitted to the mailbox servers which need to be checked, in order to update the status information when a particular subscriber is active in the telephone network.

17. The method as claimed in one of claims 13 to 16, characterized
in that a checking message is transmitted to the mailbox servers which need to be checked, in order to update the status information when a message for checking the status of his mailbox messages is received from a particular subscriber.

18. The method as claimed in one of claims 10 to 17, characterized
in that at least some of the mailbox servers are arranged in different communications networks.
